(19) United States
(12) Patent Application Publication
(10) Pub. No.: US 2015/0097832 A1
(43) Pub. Date: Apr. 9, 2015

(54) SYSTEM AND METHOD FOR MESH LEVEL OF DETAIL GENERATION

(71) Applicant: HONEYWELL INTERNATIONAL INC., Morristown, NJ (US)

(72) Inventors: Brian Rice, Albuquerque, NM (US); Timothy Dropps, Placitas, NM (US)

(21) Appl. No.: 14/047,327

(22) Filed: Oct. 7, 2013

(51) Int. Cl. G06T 15/08

(52) U.S. Cl. CPC G06T 15/08
USPC 345/424

(57) ABSTRACT

A system method for applying hierarchical mesh partitioning and reduction to provide efficient run-time rendering includes bounding a mesh to define a mesh volume, recursively subdividing the mesh volume a number of times, and reducing the mesh the number of times the mesh volume was subdivided to generate a plurality of level of detail meshes. The plurality of level of detail meshes is equal to the number of times the mesh volume was subdivided. Each level of detail mesh is then partitioned based on the number of times the mesh volume was subdivided.

### STATEMENT REGARDING FEDERALLY SPONSORED RESEARCH OR DEVELOPMENT

This invention was made with Government support under Contract Number 7005596911-002 awarded by the Intelligence Advanced Research Projects Activity (IARPA). The Government has certain rights in this invention.

### TECHNICAL FIELD

The present invention generally relates to rendering, processing, and management issues associated with relatively complex high density meshes, and more particularly relates to a system and method for mesh level of detail generation to allow relatively simple run-time management and rendering of relatively complex high density meshes.

### BACKGROUND

In computer graphics, objects may be modeled as tessellated polygonal approximations or meshes. These polygons may be even further converted to triangles by triangulation. During run-time, it is desirable to render objects by transforming the mesh into a visual display using various levels of detail (LOD). For example, when objects are close to a viewer, a detailed mesh is used; however, as objects recede further and further from a viewer, less detailed meshes are used. As may be appreciated, run-time processing, management, and rendering such modeled objects quickly and efficiently can be processor intensive.

During the rendering process, it may be necessary to switch between the different LOD that were generated. This can, however, create “holes” or discontinuities due, for example, to artifacts generated by the reduction algorithm. Ideally, one would prefer to generate relatively continuous LOD to eliminate, or at least significantly reduce, such discontinuities, while at the same time providing an acceptable level of performance and visual quality. Various reduction algorithms have been developed to generate the different LOD associated with a mesh. However, presently known reduction algorithms that eliminate, or at least significantly reduce, discontinuities require significant amounts of computational overhead during the rendering process.

Hence, there is a need for a system and method for mesh LOD generation that allows relatively simple run-time management and rendering of relatively complex high density meshes, while eliminating or at least significantly reducing, discontinuities of the rendered mesh. The present invention addresses at least this need.

### BRIEF SUMMARY

In one embodiment, a method for applying hierarchical mesh partitioning and reduction to provide efficient run-time rendering. The method is implemented in a processor and includes bounding a mesh to define a mesh volume, recursively subdividing the mesh volume a number of times, and reducing the mesh the number of times the mesh volume was subdivided to generate a plurality of level of detail meshes. The plurality of level of detail meshes is equal to the number of times the mesh volume was subdivided. Each level of detail mesh is then partitioned based on the number of times the mesh volume was subdivided.

In another embodiment, a hierarchical mesh partitioning and reduction system includes a display device and a processor. The display device is coupled to receive image rendering display commands and is configured, upon receipt thereof, to render images. The processor is in operable communication with the display device and is configured to bound a mesh to define a mesh volume, recursively subdivide the mesh volume a number of times, reduce the mesh the number of times the mesh volume was subdivided to generate a plurality of level of detail meshes, where the plurality of level of detail meshes equal to the number of times the mesh volume was subdivided, partition each level of detail mesh based on the number of times the mesh volume was subdivided, and command the display device to render segments from a single level of detail.

In yet another embodiment, a method for applying hierarchical mesh partitioning and reduction to provide efficient run-time rendering is implemented in a processor and includes bounding a mesh to define a mesh volume, recursively subdividing the mesh volume a number of times, and reducing the mesh the number of times the mesh volume was subdivided to generate a plurality of level of detail meshes. The plurality of level of detail meshes is equal to the number of times the mesh volume was subdivided. Each level of detail mesh is partitioned based on the number of times the mesh volume was subdivided, and segments from a single level of detail are rendered on a display device. The number of times that the mesh volume is subdivided is determined by calculating a metric for portions of the mesh inside each subdivision.

Furthermore, other desirable features and characteristics of the hierarchical mesh partitioning and reduction system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a system that may be used to render images;

FIG. 2 depicts a process, in flowchart form, that may be implemented by the system of FIG. Ito provide efficient run-time management and rendering of various images;

FIGS. 3-6 depict simplified representations of various steps of the process of FIG. 2; and

FIGS. 7 and 8 depict simplified representations of modifications that may be included in the process of FIG. 2 and that, for clarity, are not depicted in the flowchart.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

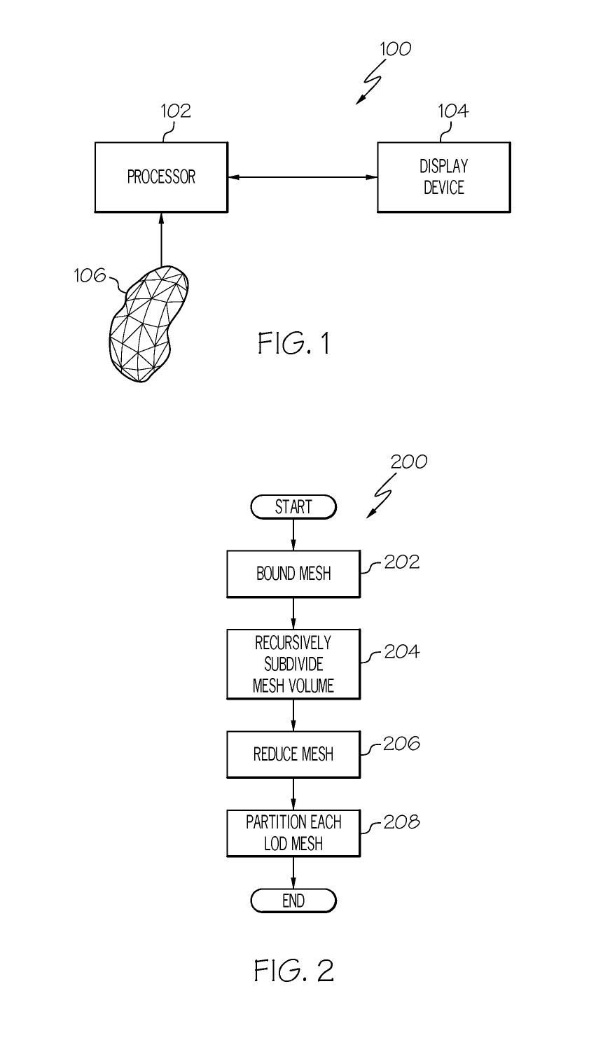

Referring to FIG. 1, a functional block diagram of one embodiment of a system 100 is depicted. The depicted system 100 may be used to, among other functions, render various types of graphics and includes at least a processor 102 and a display device 104. The processor 102 is coupled to receive and/or retrieve a tessellated model 106, or “mesh,” from one or more non-illustrated data sources. The processor 102 is configured to process the received or retrieved mesh 106 for rendering on the display device 104. In this regard, the processor 102 is also configured to supply image rendering display commands to the display device 104 that cause the display device 104 to render graphical representations of all or portions of the received mesh 106. The specific processing of the received mesh 106 that the processor 102 implements will be described in more detail further below.

The display device 104 is in operable communication with the processor 102 and is configured, upon receipt of the image rendering display commands supplied by the processor 102, to render graphical representations of all or portions of the mesh 106. The display device 104 is configured to implement any one of numerous types of 2D or 3D displays that are suitable for rendering textual, graphic, and/or iconic information in a format viewable by a non-illustrated observer. Non-limiting examples of such display devices include various cathode ray tube (CRT) displays, various flat panel displays, such as various types of LCD (liquid crystal display) and TFT (thin film transistor) displays, and a 3D light field display. The display device 104 may additionally be implemented as a panel mounted display, a HUD (head-up display) projection, or any one of numerous other known technologies.

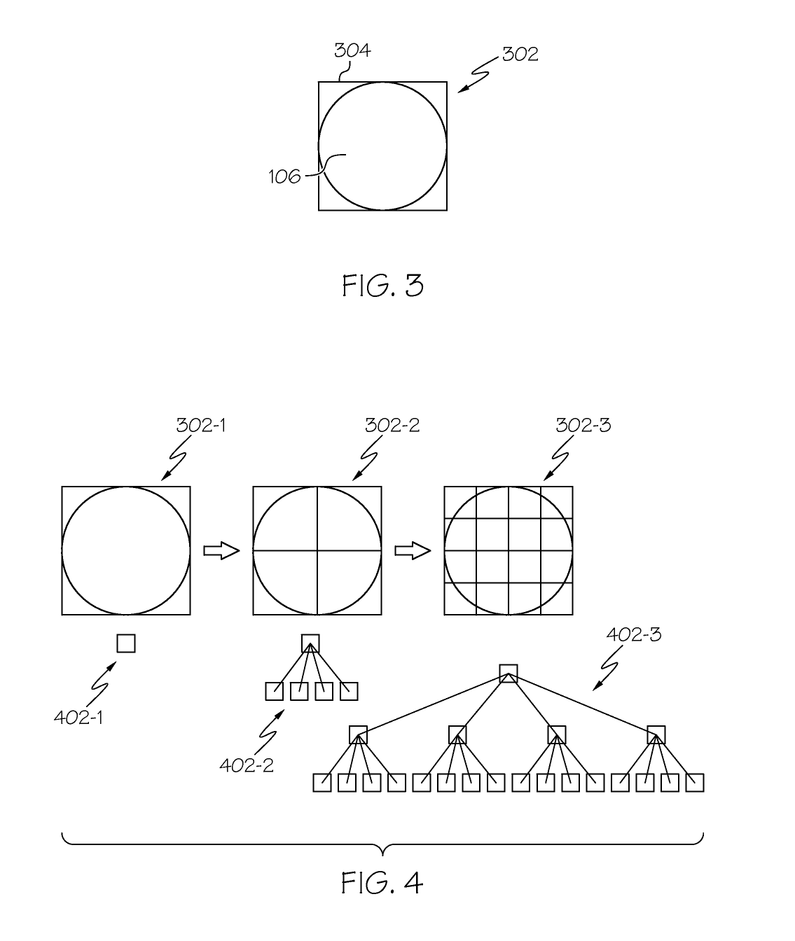

The processor 102, as previously noted, processes the received or retrieved mesh 106 for rendering on the display device 104. More specifically, the processor 102 is configured to implement a process that applies hierarchical mesh partitioning and reduction to the mesh 106, and does so in a manner that allows efficient run-time rendering on the display device 104 without introducing “holes” or other artifacts into the rendered mesh. This process 200 is depicted in flowchart form in FIG. 2, and will now be described. Before doing so, however, it should be noted that the process 200 may be applied to various types of multi-dimensional (e.g., 2D or 3D) meshes, including various types of triangle meshes, and various types of grid meshes, just to name a few. For ease of description and illustration, the process 200 will be described as being implemented on a 2D mesh. It should also be noted that the parenthetical references in the following description refer to like-numbered flowchart blocks in FIG. 2.

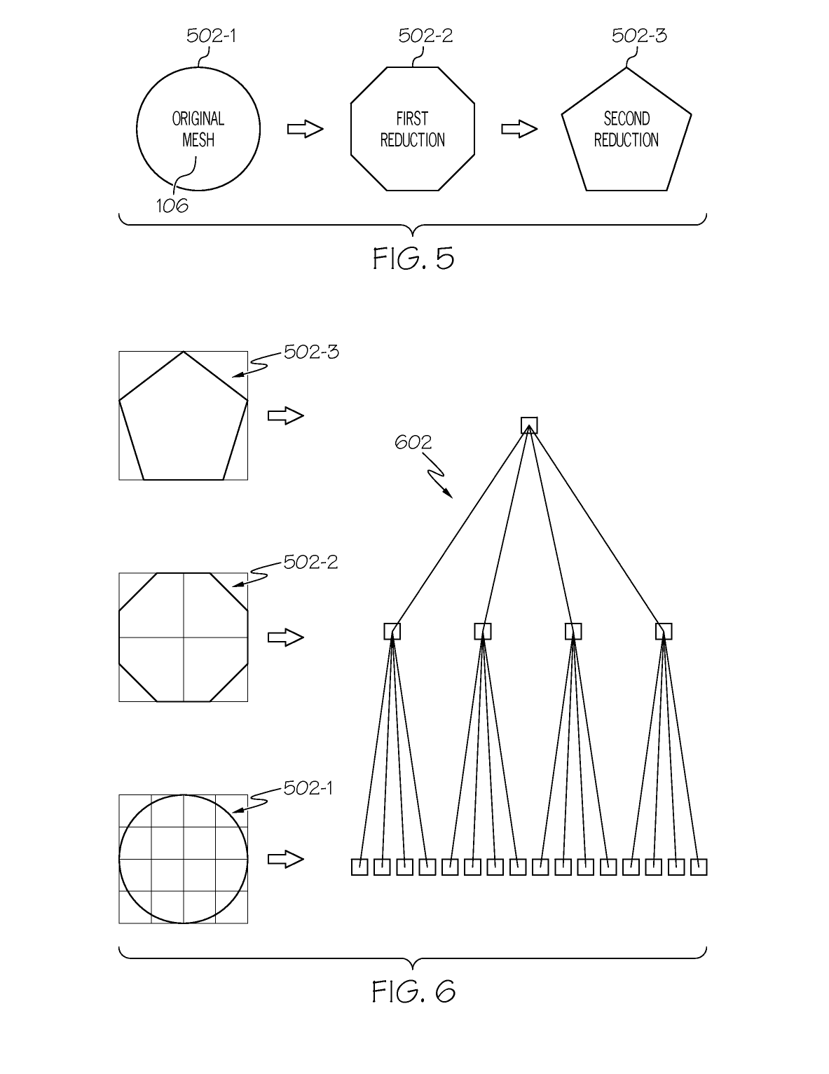

With reference now to FIG. 2, the depicted process 200 begins upon receipt or retrieval of the mesh 106. Upon its receipt or retrieval, and as illustrated in FIG. 3, the mesh 106 is bounded to define a mesh volume 302 (202). More specifically, the processor 102 draws an imaginary boundary 304 around the mesh 106. Thereafter, as illustrated in FIG. 4, the mesh volume 302 is recursively subdivided a number of times (204). As FIG. 4 also illustrates, the processor 102 may also generate a mesh tree 402 having a tree depth that is equal to the number of times the mesh volume was subdivided. It should be noted that at this point the mesh 106 is not partitioned, it is only subdivided. It will be appreciated that the mesh volume 302 may be recursively subdivided using any one of numerous known mesh subdivision processes including, for example, oct-tree, or quad-tree, just to name a few.

In the simplified example depicted in FIG. 4, the mesh volume 302 is subdivided three times, and the resulting mesh tree 402, which represents the various volumetric partitions, has a depth of three. Generally speaking, however, the number of times that the mesh volume 302 is subdivided is determined by calculating a metric for the portions of the mesh 106 inside each of the subdivisions. The particular metric may vary, but in one particular embodiment the metric is a number that is less than a predetermined number of vertices per subdivision. In other words, the mesh volume 302 is recursively subdivided until the number of vertices (or triangles) in each subdivision is less than the predetermined number. Thus, while the processor 102 is recursively subdividing the mesh volume 302, it is also counting the number of vertices within each subdivision and comparing the number of vertices to the predetermined number. It will be appreciated that the predetermined number may vary, and is preferably selected based upon the performance characteristics of the system 100.

Referring once again to FIG. 2, but this time in combination with FIG. 5, it is seen that after the mesh volume 302 is recursively subdivided, the mesh 106 (not the mesh volume) is reduced to generate a plurality of level of detail (LOD) meshes 502 (206). In particular, the entire mesh 106, which is the highest LOD, is reduced the same number of times that the mesh volume 302 was subdivided. Thus, the plurality of LOD meshes 502 (e.g., 502-1, 502-2, 502-3 . . . 502-N) is equal to the number of times that the mesh volume 302 was subdivided. It will be appreciated that the mesh 106 may be reduced using any one of numerous mesh reduction processes. It will additionally be appreciated that the target number of vertices in each reduced mesh 502 is preferably, though not necessarily, based on the overall number of vertices expected its corresponding level in the mesh tree 302. Preferably, the reduction process that is selected will reduce the vertex/triangle count while maintaining a reasonable approximation of mesh 106 appearance, and allow a target number of vertices/triangles for each LOD mesh 502 to be specified.

Having generated the plurality of LOD meshes 502, the processor 102 then partitions each LOD mesh 502 based on the number of times the mesh volume 302 was subdivided (208). As illustrated more clearly in FIG. 6, the lowest LOD mesh 502, which in the depicted example is 502-3, is not partitioned, and is the root of a corresponding mesh tree 602 that the processor 102 generates. The mesh tree 602 is balanced, all of the leaves are segments from the original mesh 106, and all of the segments at a given depth (or LOD) are partitioned from the same LOD mesh 502. As with the partitioning of the mesh volume 302, each LOD mesh 502 may be partitioned using any one of numerous known mesh subdivision processes including, for example, oct-tree, or quad-tree, just to name a few. Preferably, the partitioning process that is used will allow the mesh 106 to be clipped to a specified volume, while handling any necessary triangle creation along the edges, appropriately handling vertex attributes, and, except for the clipping, maintaining the shape of the mesh 106.

After the processor 102 has processed the received or received mesh 106 according to the above-described process 200, it may then command the display device 104 to render all, or portions, of the mesh 106. In doing so, the processor 102 will command the display device to use only segments from a single LOD. This is made possible because each LOD covers the entire original mesh 106.

The process 200 depicted in FIG. 2 and described above is relatively simple, exhibits low runtime complexity, and allows rendering of the mesh 106 with no holes or various other discontinuities that other LOD processes exhibit due to LOD mismatches between adjacent segments. This relatively simple process 200 can, however, exhibit its own issues when the original mesh 106 density is irregular. For example, due to its balanced tree partitioning, some segments at higher LOD may contain relatively few vertices. As may be appreciated, unnecessarily loading and/or rendering a lot of relatively small segments increases processing overhead. Another issue that may be exhibited is associated with the fact that the process controls for the average number of vertices per segment, but does not tightly bound the number of vertices in each individual segment. As may be appreciated, the process 200 depicted in FIG. 2 and described above may be slightly modified, if needed or desired, to address these issue. The particular modifications associated with each issue will now be described.

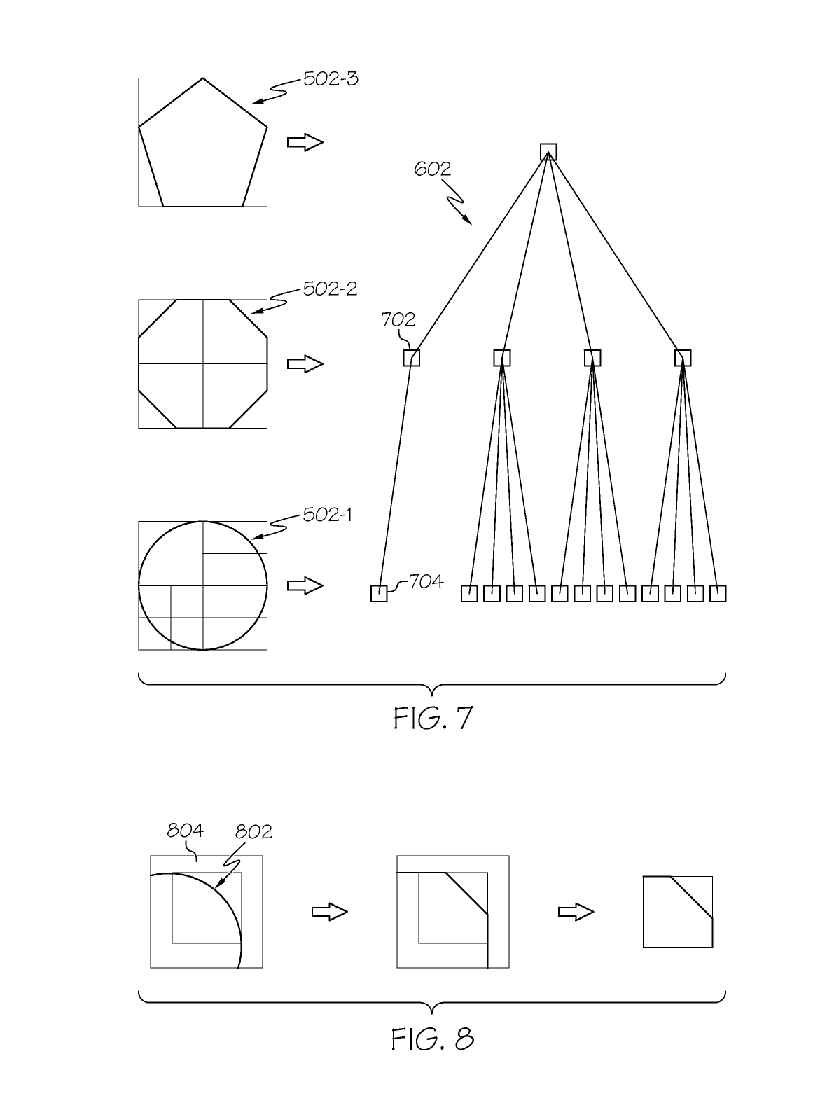

The first issue may be addressed by slightly modifying the step of the process 200 in which each LOD mesh 502 is partitioned. Specifically, this step (208) is implemented by first partitioning each LOD mesh 502 in LOD order, from the lowest level of detail to the highest level of detail, and counting the vertices within each partitioned LOD mesh 502 for the next lower LOD. When the vertices within a partitioned LOD mesh 502 is less than a predetermined number, a boundary of the next lower LOD is used. As FIG. 7 depicts, this creates a node 702 in the mesh tree 602 that has only a single child node 704. It does not, however, change the properties of resulting mesh tree 602. That is, all of the leaves are the same distance from the root, and all of the segments at given depth are from the same LOD mesh 502. As may be readily appreciated by the skilled person, for irregular density meshes 106, this modification combines small segments at higher LOD into larger segments covering larger volumes, which reduces processing overhead.

The second issue described above may be addressed by slightly modifying both the step of the process 200 in which the mesh volume 302 is recursively subdivided, and step of the process 200 in which the mesh 106 is reduced. Specifically, and as may be appreciated, when the processor 102 recursively subdivides the mesh volume 302, it generates a plurality of mesh sub-volumes. As FIG. 8 more clearly depicts, this step (204) of the process 200 is modified such that each mesh sub-volume 802 is bounded with a sub-volume boundary 804. The step of reducing the mesh 106 (206) is modified so that each mesh sub-volume 802 is reduced, and then its associated sub-volume boundary 804 is removed. These modifications to the process 200 allow tighter control of the number vertices per segment by specifying the vertex count target for each sub-volume 802 plus its associated bounding box 804, rather than entire mesh 106, which may decrease the runtime of there duce process.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for applying hierarchical mesh partitioning and reduction to provide efficient run-time rendering, the method comprising the steps of:
in a processor:
bounding a mesh to define a mesh volume;
recursively subdividing the mesh volume a number of times;
reducing the mesh the number of times the mesh volume was subdivided to generate a plurality of level of detail meshes, the plurality of level of detail meshes equal to the number of times the mesh volume was subdivided; and
partitioning each level of detail mesh based on the number of times the mesh volume was subdivided.

2. The method of claim 1, wherein the number of times that the mesh volume is subdivided is determined by calculating a metric for portions of the mesh inside each subdivision.

3. The method of claim 2, wherein the metric is a number that is less than a predetermined number of vertices per subdivision.

4. The method of claim 3, further comprising:
counting a number of vertices within each subdivision; and
comparing the number of vertices to the predetermined number.

5. The method of claim 1, further comprising:
before reducing the mesh, generating a mesh tree having a tree depth that is equal to the number of times the mesh volume was subdivided.

6. The method of claim 1, wherein:
the plurality of level of detail meshes include a lowest level of detail mesh and a highest level of detail mesh; and
the lowest level of detail mesh is not partitioned.

7. The method of claim 1, further comprising:
rendering, on a display device, segments from a single level of detail.

8. The method of claim 1, wherein the step of partitioning each level of detail mesh comprises:
partitioning each level of detail mesh in level of detail order, from lowest level of detail to highest level of detail;
counting vertices within each partitioned level of detail mesh for a next lower level of detail; and
when vertices within a partitioned level of detail mesh is less than a predetermined number, use a boundary of the next lower level of detail.

9. The method of claim 1, wherein:
the step of recursively subdividing the mesh volume a number of times generates a plurality of mesh sub-volumes;
the method further comprises bounding each mesh sub-volume with a sub-volume boundary; and
the step of reducing the mesh comprises reducing each mesh sub-volume and removing the sub-volume boundary.

10. A hierarchical mesh partitioning and reduction system, comprising:
a display device coupled to receive image rendering display commands and configured, upon receipt thereof, to render images; and
a processor in operable communication with the display device and configured to:
bound a mesh to define a mesh volume,
recursively subdivide the mesh volume a number of times,
reduce the mesh the number of times the mesh volume was subdivided to generate a plurality of level of detail meshes, the plurality of level of detail meshes equal to the number of times the mesh volume was subdivided,
partition each level of detail mesh based on the number of times the mesh volume was subdivided, and
command the display device to render segments from a single level of detail.

11. The system of claim 10, wherein the processor is further configured to:
calculate a metric for portions of the mesh inside each subdivision; and
subdivide the mesh volume based on the calculated metric.

12. The system of claim 11, wherein the metric is a number that is less than a predetermined number of vertices per subdivision.

13. The system of claim 12, wherein the processor is further configured to:
count a number of vertices within each subdivision; and
compare the number of vertices to the predetermined number.

14. The system of claim 10, wherein the processor is further configured to generate, before reducing the mesh, a mesh tree having a tree depth that is equal to the number of times the mesh volume was subdivided.

15. The system of claim 10, wherein:
the plurality of level of detail meshes include a lowest level of detail mesh and a highest level of detail mesh; and
the processor is further configured to not partition the lowest level of detail mesh.

16. The system of claim 10, wherein the processor is further configured to partition each level of detail mesh by:
partitioning each level of detail mesh in level of detail order, from lowest level of detail to highest level of detail;
counting vertices within each partitioned level of detail mesh for a next lower level of detail; and
when vertices within a partitioned level of detail mesh is less than a predetermined number, use a boundary of the next lower level of detail.

17. The system of claim 10, wherein the processor is further configured to:
recursively subdivide the mesh volume a number of times generates a plurality of mesh sub-volumes;
bound each mesh sub-volume with a sub-volume boundary; and
reduce the mesh by reducing each mesh sub-volume and removing the sub-volume boundary.

18. A method for applying hierarchical mesh partitioning and reduction to provide efficient run-time rendering, the method comprising the steps of:
in a processor:
bounding a mesh to define a mesh volume;
recursively subdividing the mesh volume a number of times;
reducing the mesh the number of times the mesh volume was subdivided to generate a plurality of level of detail meshes, the plurality of level of detail meshes equal to the number of times the mesh volume was subdivided;
partitioning each level of detail mesh based on the number of times the mesh volume was subdivided; and
rendering, on a display device, segments from a single level of detail,
wherein the number of times that the mesh volume is subdivided is determined by calculating a metric for portions of the mesh inside each subdivision.

19. The method of claim 18, wherein the step of partitioning each level of detail mesh comprises:
partitioning each level of detail mesh in level of detail order, from lowest level of detail to highest level of detail;
counting vertices within each partitioned level of detail mesh for a next lower level of detail; and
when vertices within a partitioned level of detail mesh is less than a predetermined number, use a boundary of the next lower level of detail.

20. The method of claim 18, wherein:
the step of recursively subdividing the mesh volume a number of times generates a plurality of mesh sub-volumes;
the method further comprises bounding each mesh sub-volume with a sub-volume boundary; and
the step of reducing the mesh comprises reducing each mesh sub-volume and removing the sub-volume boundary.
